(19) United States
(12) Patent Application Publication
(10) Pub. No.: US 2026/0310729 A1
(43) Pub. Date: Oct. 8, 2026

(54) MEMORY PLATFORM FOR GENERATIVE RESPONSE ENGINES

(71) Applicant: OpenAI OpCo, LLC., San Francisco, CA (US)

(72) Inventors: Samir Ahmed, San Francisco, CA (US); Christina Kaplan, San Francisco, CA (US); Constantin Koumouzelis, Mountain View, CA (US); Marvin Zhang, San Francisco, CA (US)

(73) Assignee: OpenAI OpCo, LLC., San Francisco, CA (US)

(21) Appl. No.: 19/195,022

(22) Filed: Apr. 30, 2025

Related U.S. Application Data
(60) Provisional application No. 63/784,739, filed on Apr. 7, 2025.

(51) Int. Cl. G06F 16/9032

(52) U.S. Cl. CPC G06F 16/90324

(57) ABSTRACT

Systems and methods for generating responses to user prompts using synthesized memories are disclosed. A generative response engine receives a prompt starting a conversation thread with a user account, along with a personalized memory state that includes curated knowledge about the user account and synthesized memories derived from past conversation threads involving the user account. The generative response engine uses this information to generate a response to the prompt. Synthesized memories include listings of topics and summaries of topics, which are created by evaluating past conversation threads and determining what information should be synthesized into the memories, allowing for more personalized and relevant responses to be generated.

### CROSS-REFERENCE TO RELATED APPLICATIONS

This application claims the benefit of priority to U.S. provisional application number 63/784,739, filed on Apr. 7, 2025, which is expressly incorporated by reference herein in its entirety.

### BACKGROUND

Generative response engines such as large language models represent a significant milestone in the field of artificial intelligence, revolutionizing computer-based natural language understanding and generation. Generative response engines, powered by advanced deep learning techniques, have demonstrated astonishing capabilities in tasks such as text generation, translation, summarization, and even code generation. Generative response engines can sift through vast amounts of text data, extract context, and provide coherent responses to a wide array of queries.

### BRIEF DESCRIPTION OF THE SEVERAL VIEWS OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings, and the claims.

FIG. 1 illustrates an example system supporting a generative response engine during inference operations in accordance with some embodiments of the present technology.

FIG. 2 illustrates an example context management service supporting a generative response engine during inference operations in accordance with some embodiments of the present technology.

FIG. 3 is an example table that synthesizes snippets from conversation threads into a synthesized memory and an associated topic tree in accordance with some aspects of the present technology.

FIG. 4 illustrates an example method for context management for a generative response engine in accordance with some aspects of the present technology.

FIG. 5 is a block diagram illustrating an example machine-learning platform for implementing various aspects of this disclosure in accordance with some aspects of the present technology.

FIG. 6A, FIG. 6B, and FIG. 6C illustrates an example transformer architecture in accordance with some aspects of the present technology.

FIG. 7 shows an example of a system for implementing some aspects of the present technology.

### DETAILED DESCRIPTION

Generative response engines such as large language models represent a significant milestone in the field of artificial intelligence, revolutionizing computer-based natural language understanding and generation. Generative response engines, powered by advanced deep learning techniques, have demonstrated astonishing capabilities in tasks such as text generation, translation, summarization, and even code generation.

Many generative response engines provide a conversational user interface powered by a chatbot whereby the user account interacts with the generative response engine through natural language conversation with the chatbot. Such a user interface provides an intuitive format to provide prompts or instructions to the generative response engine. In fact, the conversational user interface powered by the chatbot can be so effective that users can feel as if they are interacting with a person. Some user accounts find the generative response engine effective enough that they utilize the conversational user interface powered by the chatbot as they would an assistant.

However, one area in which these generative response engines could be improved is their ability to learn and aggregate personal information about a user associated with a user account. Current generative response engines, such as large language models, often have a limited understanding of a user account's full context and history. Such systems typically maintain a conversational context that is limited to the current dialogue or interaction, without effectively leveraging the user account's broader history, preferences, and personal information. A lack of a comprehensive user model and global state representation can result in suboptimal responses, recommendations, and personalization.

Current generative response engines typically cannot recall relevant past information, understand the user's long-term goals and interests, or tailor its outputs to the user's unique needs and preferences. As users engage with these generative response engines more frequently and across various domains, the need for a robust and personalized memory state becomes increasingly important.

Maintaining a rich, multi-faceted representation of the user's context, knowledge, and history could enable significantly more personalized and coherent interactions. However, developing such a personalized memory state that can be effectively utilized by the language model presents technical challenges around data storage, retrieval, and integration into the conversational flow.

The present technology addresses these problems by allowing a context management service to create a personalized memory state that may include curated knowledge about the user account and synthesized memories that are derived from past conversations involving the user account, as well as in cases, short-term memory that includes at least a portion of recent conversation threads. By receiving these distinct features in a context window, the generative response engine can provide more accurate and relevant responses to users' queries.

Generative response engines such as large language models represent a significant advancement in natural language processing (NLP) technology, enabling computers to understand and respond to human language like never before. However, despite their impressive capabilities, these systems still struggle to fully comprehend the nuances of human communication and behavior. To overcome this limitation, the present technology introduces the concept of personalized memory states that can capture an individual's unique preferences, interests, and experiences. The personalized memory state is a critical component of the system, as it provides the foundation for the generative response engine to generate accurate and relevant responses. This personalized memory state includes at least one of these main components: curated knowledge, synthesized memories, and short-term memory.

Curated knowledge represents the user's preferences, interests, and expertise identified by the generative response engine. This information is identified by the generative response engine during interactions between the user account and the generative response engine. For example, a user might provide fact or preference in a prompt to the generative response engine, which the generative response engine can identify as data that should be remembered. Some examples might be the name a person's pet, their favorite coffee shop, favorite color, etc. In some aspects, these facts could also be learned by online research about the user account for the purpose of learning the curated knowledge. The curated knowledge is specific knowledge about the user account or the preferences thereof that is identified by the generative response engine as data that should be remembered. The curated knowledge component of the personalized memory state serves as a starting point for the generative response engine to draw upon when generating responses.

Short-term memory refers to the most recent information that is actively being used in the current conversation. Short-term memory may be constructed on-the-fly based on the user's current interaction and is typically limited by recency and an available context window. The inclusion of short-term memory complements the other components of the personalized memory state in that it focuses on the most recent conversations which places an emphasis on more recent details in the personalized memory state. This aligns with how an assistant is more likely to remember conversations that happened more recently.

Synthesized memories, on the other hand, is an output from a machine learning (ML) model that approximates what the ML model should remember about the user account if the ML model were that their assistant. These summaries go beyond mere preferences and behaviors, instead providing a condensed record of past interactions between the ML model and the user. Moreover, synthesized memories can be generated across conversations, connecting disparate concepts that may have appeared in separate conversation threads. These synthesized memories may be derived from analyzing patterns and trends in the user's interactions over time. Additionally, the synthesized memories can be dynamically generated and updated by a context management service, ensuring they remain relevant and accurate. In some cases, the ML model contextualizes insights from the long-term memory storage and selectively adding them to the short-term memory.

As such, the short-term memory is the immediate, real-time context, while the synthesized memories are pulled from a longer-term history and contextualized into the short-term memory to enhance the short-term understanding of the user.

The contextualization process is what connects the long-term and short-term memory components to provide a comprehensive understanding of the user's preferences and interests. Update cycles would be necessary to regularly update the short-term memory component to reflect changes in the user's behavior and preferences, ensuring that the system remains accurate and relevant.

By combining curated knowledge, synthesized memories, and short-term memory, an AI assistant service can provide more accurate and relevant responses to users' queries. The inclusion of short-term memory provides the generative response engine with recent interactions between the generative response engine and the user account, and the synthesized memories provide the generative response engine with context gathered from conceptual connections that have occurred over a longer period of interactions, overcoming several challenges in traditional memory systems. Furthermore, the use of contextualization and update cycles ensures that the system remains accurate and relevant, providing a robust framework for generating personalized responses.

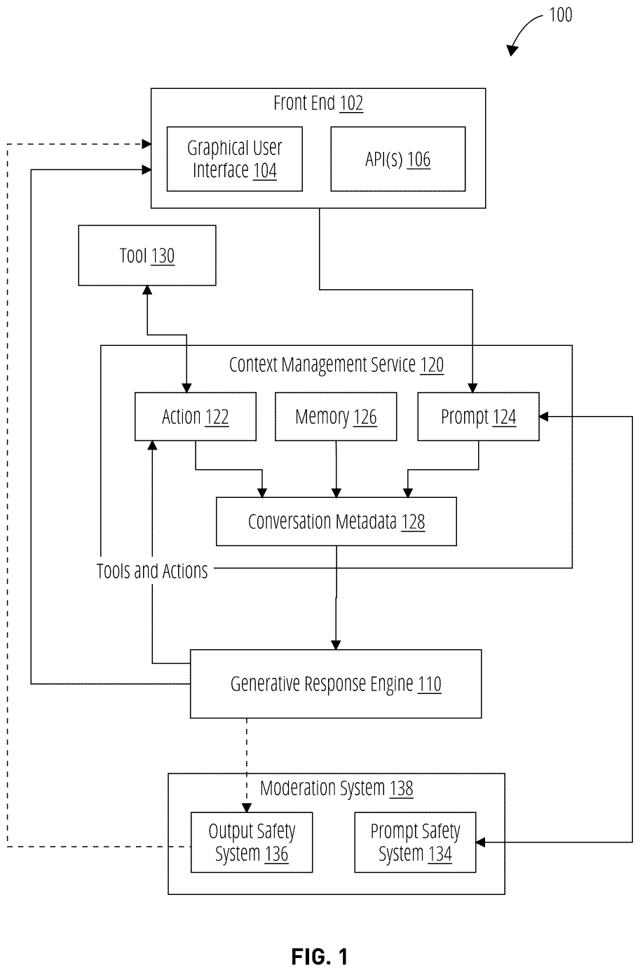

FIG. 1 illustrates an example AI assistant service supporting a generative response engine during inference operations in accordance with some embodiments of the present technology. Although the example system depicts particular system components and an arrangement of such components, this depiction is to facilitate a discussion of the present technology and should not be considered limiting unless specified in the appended claims. For example, some components that are illustrated as separate can be combined with other components, and some components can be divided into separate components.

The generative response engine 110 is an artificial intelligence (AI) that can generate content in response to a prompt. The prompt can be from a human or a software entity (AI or applications). The prompt is generally in natural language but could be in code, including binary. Some examples of the generative response engine can include language models that generate language, such as CHATGPT, or other models, such as DALL-E, which generates images, and SORA, which generates videos. CHATGPT, DALL-E, and SORA are all provided by OPENAI, but the generative response engine is not limited to AI provided by OPENAI. The generative response engine can also be any type of generative AI and can include AI developed using various architectures such as diffusion models and transformers (e.g., autoregressive transformer architecture) and combinations of models.

In some instances, a language model, such as CHATGPT, can receive prompts to output images, video, code, applications, etc., which it can provide by interfacing with one or more other models, as will be addressed further herein.

Users and applications can interact with the generative response engine 110 through the front end 102. The front end 102 serves as the interface and intermediary between the user and the generative response engine. It encompasses the graphical user interface 104 and Application Programming Interfaces (APIs) 106 that facilitate communication, input processing, and output presentation.

Generally, users interact through a graphical user interface 104 that often includes a conversational interface, and applications interact through the API 106, but this is not a requirement.

The graphical user interface 104 is the platform through which users interact with the generative response engine 110. It can be a web-based chat window, a mobile application, or any interface that supports data input and output. The graphical user interface 104 facilitates a conversation between the user and the generative response engine, as the user provides prompts in the graphical user interface 104 to which the generative response engine responds and presents those responses in the graphical user interface 104. In some embodiments, graphical user interface 104 presents a conversational interface, which has attributes of a conversation thread between a user account and generative response engine 110.

The graphical user interface 104 is configured to perform input handling, context management, and output presentation. The type of inputs that can be received can be relative to the specifics of the generative response engine 110.

For example, a language model is generally configured to accept text, but when the generative response engine is a multi-modal generative response engine, the front end 102 can accept voice and images/video.

In some embodiments, front end 102 can be an interface to accept any input types as part of the prompt, and downstream services can determine which generative response engine or collection of generative response engines are best suited to respond to the prompt.

The graphical user interface 104 is also configured to maintain the context of the conversation, which allows for coherent and relevant responses. For example, the graphical user interface 104 is responsible for providing the conversation thread and other relevant context accessible to the front end 102 to the generative response engine along with the specific prompt to the generative response engine. In an example, a conversation between the user account and the generative response engine 110 can have taken several turns (prompt, response, prompt, response, etc.). When the user account provides a further prompt, the graphical user interface 104 can provide that prompt to the generative response engine in the context of the entire conversation.

In another example, the graphical user interface 104 might be configured to provide a system prompt along with a user-provided prompt. A system prompt is hidden from the user account and is used to set the behavior and guidelines for the generative response engine. It can be used to define the AI's persona, style, and constraints. There can be levels of system prompts. A highest level of a system prompt might be provided by the generative response engine 110 provider and its meant to establish policies for the behavior of generative response engine 110.

This highest level OS system prompt should is prohibited from being edited. A customization system prompt can be used to customize the behavior of the generative response engine and is often provided through an API call, or provided by a user account when creating a customized version of generative response engine 110. A still lower level of system prompt might include hidden information about a task. This can include chain-of-thought from a reasoning model, or context about an application the generative response engine 110 is working with to complete a task. Accordingly, the graphical user interface 104 does not always display all of the output of the generative response engine.

The graphical user interface 104 is also configured to display the responses from the generative response engine, which might include text, code snippets, images, or interactive elements.

In some embodiments, the generative response engine 110 can provide instructions to the front end 102 that instruct the graphical user interface 104 about how to display some of the output from the generative response engine. For example, the generative response engine can direct the graphical user interface 104 to present code in a code-specific format, or to present interactive graphics, or static images. In other examples, the generative response engine can direct the graphical user interface 104 to present an interactive document editor where the graphical user interface 104 can be presented with the document editor so that the user account and the generative response engine can collaborate on the document.

In some embodiments, the generative response engine 110 can provide instructions memory 126 to record facts in a personalization notepad, and front end 102 can be configured to notify the user account that a memory was created.

As noted above, the front end 102 can also provide one or more application programming interfaces (API(s)) 106. APIs enable developers to integrate the generative response engine's capabilities into external applications and services. They provide programmatic access to the generative response engine, allowing for customized interactions and functionalities. While APIs 106 are shown as part of a front end 102, this illustration takes the liberty of locating API 106 in front end 102 to refer to points of access to generative response engine 110 (i.e., graphical user interface 104 and APIs 106 are points of access and generative response engine 110 sends and receives messages to them in similar ways). In reality, API 106 endpoints are located at context management service 120.

The APIs 106 can accept structured requests containing prompts, context, and configuration parameters. For example, an API can be used to provide prompts and divide the prompt into system prompts and user prompts. In some embodiments, the APIs 106 can provide specific inputs for which the generative response engine 110 is configured to respond with a specific behavior. For example, an API can be used to specify that it requires an output in a particular format or structured output. For example, in the chat completion API, the API call can specify parameters for the output, such as the max length for the desired output, and specify aspects of the tone of the language used in the response. Some common APIs are for participating in a conversation (Chat Completion API), for providing a single response (Completion API), for converting text into embeddings (Embeddings API), etc. The API can also be used to indicate specific decision boundaries that the generative response engine 110 might be trained to interpret. For example, the moderation API can take advantage of the AI assistant service 100's content moderation decision-making. In the case of the moderation API and others, the API might give access to services other than the generative response engine. For example, the moderation API might be an interface to moderation system 138, addressed below.

Some other common APIs include the Fine-Tuning API, which allows developers to customize models of the generative response engine using their own datasets; the Audio and Speech APIs, which cause the generative response engine to output speech or audio; and the Image Generation API, which causes the generative response engine to output images (which might require utilizing other models).

There can also be APIs that direct the generative response engine to interface with other applications or other generative AI engines. In such cases, the specific application or AI engine might be specified, or the generative response engine might be allowed to choose another application of AI engine to utilize in response to a prompt.

In short, the graphical user interface 104 and the APIs 106 can be used to provide prompts to the generative response engine. Prompts are sometimes differentiated into prompt types. For example, a system prompt can be a hidden prompt that sets the behavior and guidelines for the generative response engine. A user prompt is the explicit input provided by the user, which may include questions, commands, or information.

Sitting in between front end 102 and generative response engine 110 is a context management service 120. The function of context management service 120 is to manage and organize the flow of data among key subsystems, enabling the generative response engine 110 to generate responses that are contextually relevant, accurate, and enriched with additional information as required.

Action 122 facilitates auxiliary tasks that extend beyond basic text generation. In some embodiments, action 122 can be actions that correspond to an API 106. In some embodiments, action 122 can be agentic actions that the generative response engine 110 decides to take to carry out a user's intent as described in the prompt. For example, an action can be to call tool 130 or even another generative response engine 110.

Prompt 124 is the request or command provided by the user account through front end 102. In some embodiments, prompt 124 can be further supplemented by a system prompt and other information that might be included by graphical user interface 104 or API 106 or associated with a custom generative response engine 110. In some embodiments, prompt 124 can even be modified or enhanced by generative response engine 110 as addressed further below.

Additionally, as the user account provides prompts and generative response engine 110 provides responses, a conversation thread forms. As the user account provides a new prompt, this is appended to the overall conversation and added to prompt 124. Thus, a user account might think of a first user-provided message as a first prompt and a second user-provided message as a second prompt, and so on, but prompt 124 as perceived by generative response engine 110 can include a thread of user-provided messages and responses from generative response engine 110 in a multi-turn conversation. The actors in the conversation thread can be labeled so that generative response engine 110 can review the turns of the conversation.

Generally, prompt 124 will include an entire conversation thread, but in some instances, prompt 124 might need to be shortened if it exceeds a maximum accepted length (generally measured by a number of tokens).

Context management service 120 can also route prompts and response through moderation system 138. In some embodiments, prompts are provided to prompt safety system 134 before being provided to generative response engine 110. Prompt safety system 134 is configured to use one or more techniques to evaluate prompts to ensure a prompt is not requesting generative response engine 110 to generate moderated content. In some embodiments, prompt safety system 134 can utilize text pattern matching, classifiers, and/or other AI techniques.

Since prompts can evolve over time through the course of a conversation, consisting of prompts and responses, prompts can be repeatedly evaluated at each turn in the conversation.

Memory 126 can facilitate continuity and personalization in conversations. It allows the system to maintain user-specific context, preferences, or details that may inform future interactions. A memory file can be persisted data from previous interactions or sessions that provide background information to maintain continuity. In some embodiments, memory can be recorded at the instruction of generative response engine 110 when generative response engine 110 identifies a fact or data that it determines should be saved in memory because it might be useful in later conversations or sessions. In some embodiments, memory 126 can also include synthesized concepts extracted from past conversation threads, and memory 126 can also encompass the ability of generative response engine 110 to search through past interactions to find relevant information to a current conversation thread.

Conversation metadata 128 can aggregate data points relevant to the conversation, including user prompt 124, action 122, and memory 126. This consolidated information package serves as the input for generative response engine 110. Conversation metadata 128 can label parts of a prompt as user provided, generative response engine provided, a system prompt, memory 126, data from action 122 or tool 130 (addressed below).

The generative response engine is the core engine that processes inputs (from context management service 120) and generates outputs. In some embodiments, the generative response engine is a generative transformer, or autoregressive transformer, but it could utilize other architectures. In some examples, the transformer is multi-modal transformer that can use audio tokens (or embeddings thereof), visual tokens (or embeddings thereof), and language (or embeddings thereof) as needed.

A core feature of the generative response engine 110 is to generate content in response to prompts. The generative response engine 110 is configured to receive inputs from front end 102 that provide guidance on a desired output. The generative response engine can analyze the input and identify relevant patterns and associations in the data, and it has learned to generate a sequence of tokens that are predicted as the most likely continuation of the input. The generative response engine 110 generates responses by sampling from the probability distribution of possible tokens, guided by the patterns observed during its training. Two features of the autoregressive transformer that result in this functionality are that the autoregressive transformer might use only the decoder part of the transformer architecture and that it utilizes self-attention. By utilizing the decoder part of the transformer architecture, the transformer focuses on predicting the tokens given the previous context tokens. And the self-attention mechanism captures long-range dependencies amongst tokens, allowing it to generate contextually relevant responses (in text, audio, images, and video).

In some embodiments, the generative response engine 110 can generate multiple possible responses before presenting the final one. The generative response engine 110 can generate multiple responses based on the input, and these responses are variations that the generative response engine 110 considers potentially relevant and coherent.

In some embodiments, the generative response engine 110 can evaluate generated responses based on certain criteria. These criteria can include relevance to the prompt, coherence, fluency, and sometimes adherence to specific guidelines or rules, depending on the application. Based on this evaluation, the generative response engine 110 can select the most appropriate response. This selection is typically the one that scores highest on the set criteria, balancing factors like relevance, informativeness, coherence, and content moderation instructions/training.

In some embodiments, an instruction provided by an API 106, a system prompt, or a decision made by generative response engine 110 can cause the generative response engine 110 to interpret a prompt and re-write it or improve the prompt for a desired purpose. For example, generative response engine 110 can determine to take a prompt to make a picture and enhance the prompt to yield a better picture. In these instances, generative response engine 110 can generate its own prompts, which can be provided to a tool 130 or provided to generative response engine 110 to yield a better output response than the original prompt might have.

The generative response engine 110 can also do more than generate content in response to a prompt. In some embodiments, the generative response engine 110 can utilize decision boundaries to determine the appropriate course of action based on the prompt. In some examples, a decision boundary might be used to cause the generative response engine to recognize that it is being asked to provide a response in a particular format such that it will generate its response constrained by the particular format. In some examples, a decision boundary can cause the model to refuse to generate a responsive output if the decision is that the responsive output would violate a moderation policy. In some examples, the decision boundary might cause the generative response engine to recognize that it needs to interface with another AI model or application to respond to the prompt. For example, when the generative response engine is a language model, it might recognize that it is being asked to output an image, and therefore, it needs to interface with a model that can output images to provide a response to the prompt. In another example, the prompt might request a search of the Internet before responding. The generative response engine can use a decision boundary to recognize that it should conduct a search of the Internet and use the results of that search in responding to the prompt. In another example, the prompt might request that the generative response engine take an agentic action on behalf of the user by interacting with a third-party service (e.g., book a reservation for me at . . . ) , and the generative response engine can utilize a decision boundary to recognize that it needs to plan steps to locate the third-party service, contact the third-party service, and interact with the third-party service to complete the task and then report back to the user that the action has been completed.

When generative response engine 110 determines that it should take an agentic action on behalf of the user or it should call a tool to aid in providing a quality response to the user account, the generative response engine 110 might call a tool 130 or cause an action 122 to be performed. As indicated above, tools 130 can include internet browsers, editors such as code editors, other AI tools etc.

Actions 122 are actions that the generative response engine 110 can cause to be performed, perhaps using tool 130. As used herein actions 122 should be considered to cover a broad array of actions that generative response engine 110 can perform with or without tools 130. Tools 130 are considered to cover a wide variety of services and software that encompass tools such as a computer operating system such that the generative response engine 110 can control the computer operating system on the user's behalf, to robotic actuators, to search browsers and specific applications.

Additionally, the generative response engine 110 can also generate portions of responses that are not displayed to the user. For example, the generative response engine 110 can direct the front end 102 to provide specific behaviors, such as directions for how to present the response from the generative response engine 110 to the user account. In another example, the generative response engine 110 can provide response portions dictated by an API, where portions of the response to the API might be for the consumption of the calling application but not for presentation to the end user. In another example, some generative response engine 110 are reasoning models, which are generative response engine 110 that are configured to output a raw chain-of-thought before preparing a final response to a prompt. The raw chain-of-thought might not be presented to a user account or application calling an API. Instead, another generative response engine 110 might summarize the raw chain-of-thought into a more consumable and useful output for the user account or application.

In some embodiments, the output of generative response engine can be further analyzed by output safety system 136. While generative response engine 110 can perform some of its own moderation, there can be instances where it is desired to have another service review outputs for compliance with the moderation policy. The use of dashed lines in FIG. 1 differentiates a path using output safety system 136 and not using output safety system 136.

While FIG. 1 shows responses being provided back to front end 102 directly, in some embodiments, the responses might be returned by way of context management service 120.

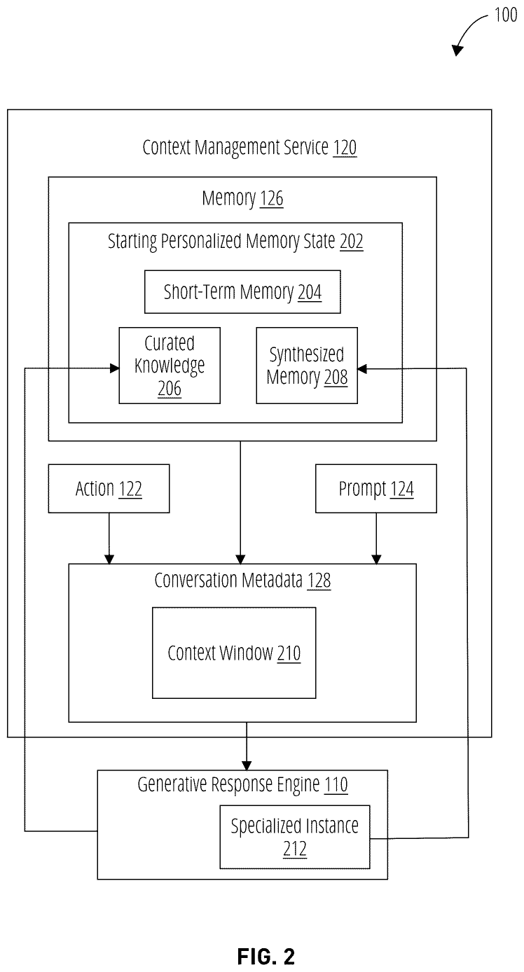

FIG. 2 illustrates an example context management service supporting a generative response engine during inference operations in accordance with some embodiments of the present technology.

The context management service 120 of FIG. 1 may further include a memory 126 that includes a personalized memory state 202. The personalized memory state 202 may include curated knowledge 206 about the user account and synthesized memories 208 that are derived from past conversation threads involving the user account. In some cases, the personalized memory state 202 additionally includes short-term memory 204. The short-term memory 204 may include at least a portion of recent conversations threads.

Curated knowledge 206 may include pre-existing information or metadata associated with an identity, interests, or behavior associated with a user account that has been carefully selected, organized, and made available for use in the personalized memory state 202. For example, this can include a structured understanding about the user account's preferences in how they want responses, interests and disinterests, points of view, shared experiences, and characteristics.

For example, if a user account shared “I love trying new restaurants,” the curated knowledge 206 might capture this sentiment as a “foodie” with a preference for trying new culinary experiences.

Synthesized memories 208, on the other hand, may be generated from past conversation threads involving the user account by a specialized instance 212 of the generative response engine 110. In some cases, the specialized instance 212 evaluates the past conversation threads, and creates the synthesized memories 208. The specialized instance 212 of the generative response engine 110 may be trained to determine what information should be synthesized into the synthesized memories 208. The synthesized memories 208 may be abstracted representations of experiences, thoughts, and feelings of the user account.

The conversation thread is a sequence of interactions between the user and the generative response engine 110, including an exchange of prompts, responses, and feedback. A user account can have many different conversation threads with the generative response engine 110 that can be stored in association with the user account so that the user account can pick up past conversations by interacting with past conversation threads. Continuing the example above, if the user account has had several past conversations with the system about questions regarding new restaurants, discussing their dining experiences, and sharing their food preferences, the context management service 120 could synthesize a higher-level “memory” that captures the essence of the user's behavior and interests, even if the specific details of the past conversations are not retained.

For example, a stored synthesized memory 208 may recite that: “Jane enjoys exploring new and innovative dining experiences, seeking out unique cuisine and restaurant concepts. They are adventurous in their food tastes and appreciate learning about different culinary styles and flavors.” The synthesized memory may also reference the conversation threads from which the synthesized memory was derived. As such, the synthesized memory 208 goes beyond just the literal statements made in past conversations. It represents an AI-generated understanding and abstraction of the user's overall dining preferences and behaviors, distilled from the conversational history. A key difference between curated knowledge 206 and synthesized memories 208 is that synthesized memories 208 may be created by the context management service 120 by creating associations across conversation threads, while curated knowledge might be directly capture preferences or facts that are, at least initially, derived from a single conversation thread. It may be the curated knowledge can be periodically reviewed and similar facts might be condensed, which might result in some association amongst conversation threads, but such association is incidental and not explicitly desired.

In some cases, the synthesized memories 208 may include audio or visual data, especially if the synthesized memories 208 are synthesized from prompts and/or responses that are associated with audio or visual features. In some cases, the synthesized memories 208 include a listing of topics derived from the conversation threads and/or a summary of at least one topic that has occurred in the conversation threads. The summary could be about a topic that occurred in a single conversation thread that the specialized instance 212 found relevant, which may include the whole topic of that conversation thread, or just a part of that conversation thread. Alternatively, the topic could have occurred in more than one conversation thread and by summarizing the topic, the specialized instance 212 creates relationships between the conversation threads based on the shared topic.

These summaries of the topics are effective to alert the generative response engine that conversations exist covering these topics.

Based on information in the synthesized memories 208, the generative response engine 110 may determine to search an archive of past interactions to learn more about at least one topic in the listing of topics that is part of the synthesized memories 208. In some cases, the synthesized memories 208 can be associated with at least one thread ID, which may help the specialized instance 212 determine which conversation threads to reference for a full context of the relevant prior conversations.

In some cases, the learned preferences may be data stored based on feedback from the user account, such as when the user account responds to a response by giving a thumbs up or a thumbs down. In some cases, the learned preferences may be pulled from the archive of past interactions, the synthesized memories 208, or a combination thereof.

In some cases, the training of the specialized instance 212 may utilize Reinforcement Learning from Human Feedback (RLHF) that involves fine-tuning the language model using human feedback, rather than relying on the original training data. Humans may provide ratings, preferences, or other signals to indicate whether the model's outputs are desirable or not. The generative response engine 110 may then be updated using reinforcement learning, adjusting the model weights to generate outputs that better align with the human feedback.

However, in some cases, end-to-end training using an objective may be employed, such as summarizing past interactions into a midterm working memory against the objective of how useful the summarizations are. This approach allows the generative response engine 110 to learn from the cumulative effects of multiple interactions, refining its understanding of the user's preferences and behaviors over time. By leveraging both RLHF and end-to-end training methods, the generative response engine 110 can adapt to changing user needs and feedback, ultimately generating more accurate and effective responses that meet the user's evolving expectations.

In some cases, the personalized memory state 202 is inserted into a context window 210. The context window 210 may be a finite space (measured in number of tokens) within which the generative response engine 110 processes and considers information provided in the prompt 124 and the personalized memory state 202, taking into account preferences and relevant past conversations of the user account, as well as other relevant context.

In some cases, for evaluating the past conversation threads and creating the synthesized memories 208, the specialized instance 212 analyzes the user's interactions with the AI assistant service 100, identifying patterns and trends, and generating abstracted representations of their experiences, thoughts, and feelings. In some cases, the specialized instance 212 performs the evaluation in an asynchronous, off-line process. The specialized instance 212 may use various techniques, such as natural language processing (NLP) and machine learning algorithms, to identify relevant information and generate cohesive and meaningful synthesized memories 208. In some cases, the asynchronous evaluation of the past conversation threads is triggered after a threshold number of conversation threads have occurred that have not previously been evaluated.

In some cases, the addition of short-term memory 204 may complement the curated knowledge 206 and the synthesized memories 208 of the personalized memory state 202. The inclusion of short-term memory 204 as part of the personalized memory state 202 may overcome several challenges. Traditionally, memory systems have focused on storing long-term knowledge and experiences while neglecting the importance of recent events and interactions. However, by incorporating short-term memory 204, the system can better address recency bias in human interactions and memory. The short-term memory 204 component may include a portion of recent conversations threads or summaries thereof, which may be limited by recency and the available space of the context window 210. As such, only a certain number of recent interactions can be stored in the context window 210, and older conversations are gradually lost or replaced with new ones. By adding the short-term memory into the context window, the generative response engine will have more context about recent conversations, just as a human assistant is more likely to clearly remember more recent interactions than more distant ones. In some cases, the process of contextualization that connects the long-term knowledge of the synthesized memories 208 within the context of the short-term memory 204 can provide a more comprehensive understanding of the user's preferences and interests.

For example, a user, John, is interacting with the personalized memory system to plan a trip to Japan. Initially, John provides some information about his travel preferences, such as his interest in trying new foods and visiting historical sites. The system generates a personalized memory state 202 that includes facts about John himself, such as his age (26), location (California), and demographic characteristics. The synthesized memories 208 from previous conversations suggest that John is an adventurous person who enjoys learning about different cultures. Additionally, the curated knowledge 206 of popular Japanese cuisine provides information on various traditional dishes and ingredients.

However, before embarking on his trip, John suddenly receives an email from a friend inviting him to attend a food festival in Tokyo. This recent event is recorded as part of the short-term memory 204 component of the system, which captures this new information and stores it temporarily alongside the existing curated knowledge 206 and synthesized memories 208. The short-term memory 204 component includes only a limited number of recent conversations threads, such as this email exchange with his friend. As time passes, older conversations are gradually lost or replaced with new ones, adhering to the constraint of the available space in the context window 210. To contextualize the short-term memory 204 with more long-term knowledge, the system can analyze the connection between John's interest in trying local foods and the food festival invitation. This analysis reveals that the festival features a variety of traditional Japanese cuisine, including dishes that align with John's interests. The synthesized memories 208 from previous conversations about Japanese culture also suggest that this type of event is often tied to cultural celebrations and traditions.

By integrating the short-term memory 204 component with the curated knowledge 206 and synthesized memories 208, the personalized memory state 202 can provide a more comprehensive understanding of John's preferences and interests. With an enhanced contextualization, the AI assistant service 100 offers more personalized recommendations for John's trip, such as suggestions for restaurants or food stalls at the festival that align with his interests.

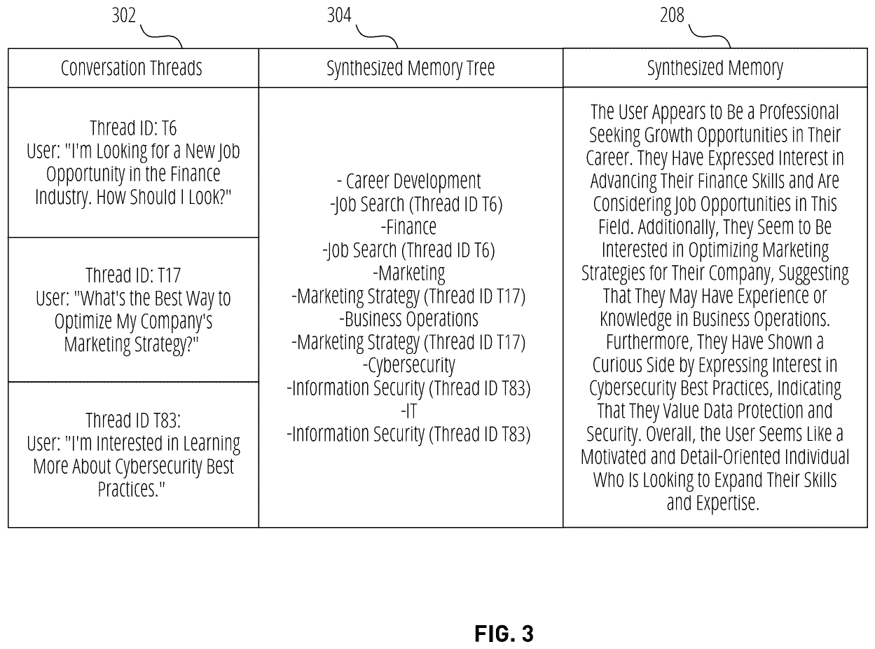

FIG. 3 is an example table that synthesizes snippets from conversation threads into a synthesized memory and an associated topic tree in accordance with some aspects of the present technology.

As illustrated in FIG. 3, a left-hand column displays snippets of conversation threads 302, specifically three conversational snippets with thread IDs of T6, T17, and T83 that were extracted from user interactions with the AI assistant service 100. These snippets represent prompts 124 issued by the user account, which hold significant value as they inherently reveal crucial information about the user's preferences, interests, and intentions.

More specifically, prompts 124 provide insight into the user's identity, needs, and goals, as they explicitly or implicitly convey their thoughts, questions, and concerns. By analyzing these prompts, the system can gain a deeper understanding of the user's personality, values, and behavior patterns, ultimately enabling more effective and personalized interactions with the AI assistant service.

In this context, the conversation snippets T6, T17, and T83 may serve as representations of the user's language patterns, tone, and style, allowing the system to refine its understanding of their preferences and adapt its responses accordingly. For example, language patterns, tone, and style may indicate aspects of the user's personality, such as their level of formality, humor, or emotional intelligence, which can provide clues about their preferences and values. This approach allows the system to make educated guesses about the user's profile without having explicit knowledge of their individual characteristics. By analyzing language patterns, tone, and style, the system can infer aspects of the user's personality that may not be immediately apparent from the words themselves. However, it's essential to note that these inferences are based on the baked-in values and heuristics that humans extract from conversation, rather than any explicit information about the user. This approach relies on the model's ability to recognize patterns and relationships in language that may not be immediately apparent to human observers.

By integrating these insights, the generative response engine 110 can create a more accurate and comprehensive profile of the user, ultimately enhancing the overall quality of the interactions with the AI assistant service 100.

A middle column presents a synthesized memory tree 304 that specifically calls out various categories/subcategories of user interest based on the conversation threads 302: Career Development, Job Search, Finance, Marketing Strategy, Business Operations, Cybersecurity, Information Security, and IT. The synthesized memory tree 304 illustrates the relationship between conversational snippets and its corresponding category of user interest. Specifically, it is shown that:
T6 (Job Seeker) appears under both “Career Development” and “Finance”, indicating the user's desire for growth opportunities in these fields.
T17 (Marketing Enthusiast) falls under both “Marketing Strategy” and “Business Operations”, suggesting the user's experience or knowledge in optimizing marketing strategies and business operations.
T83 (Cybersecurity Curious) is categorized under both “Information Security” and “IT”, highlighting the user's interest in learning more about cybersecurity best practices.

The right-hand column displays a synthesized memory 208 that has been generated based on the conversational snippets and in some cases, the synthesized memory tree 304 (or in other cases, the synthesized memory tree 304 is generated based on the synthesized memory 208). This synthesized memory 208 takes into account the user's interests in the multiple categories.

The synthesized memory 208 may tap into a rich tapestry of connections between the various categories of user interest, demonstrating how individual conversational snippets can be woven together to form a portrait of the user's preferences and goals. For instance, the presence of both “Career Development” and “Job Search” under T6 suggests that the user is actively seeking professional growth and advancement, while the inclusion of “Finance” reinforces this notion by implying a desire for financial stability or security. Conversely, the juxtaposition of “Marketing Strategy” and “Business Operations” under T17 implies that the user has expertise in both areas, and may be well-versed in marketing and business management.

However, it is also possible to infer implicit features about the user's personality or values through these connections-For example, the presence of “Cybersecurity” alongside “Finance” might suggest a user who values data protection and security, potentially implying a more cautious or risk-averse approach to financial decision-making. Alternatively, the absence of explicit relationships between categories may instead suggest implicit features about the user's priorities or interests-for instance, if T6 and T17 are not connected by any commonalities, though it may indicate that the user is highly specialized in their field, with little overlap in their areas of interest or expertise. Through careful analysis of these connections and relationships, the synthesized memory 208 can provide valuable insights into the user's underlying motivations and values.

In some cases, the personalized memory state 202 may be derived from one or more generative response engines 110 provided by a generative response engine service provider. The synthesized memories 208 may include portions of two or more conversation threads. For example, T6 and T83 may have been prompts sent to different generative response engines 110. As such, the synthesized memories 208 may further include inferences, conclusions, connections, and/or relationships derived from the past conversation threads. As such, different instances of the same model version may be interacted with such that when different model versions are interacted with over time, the synthesized memories 208 are retained.

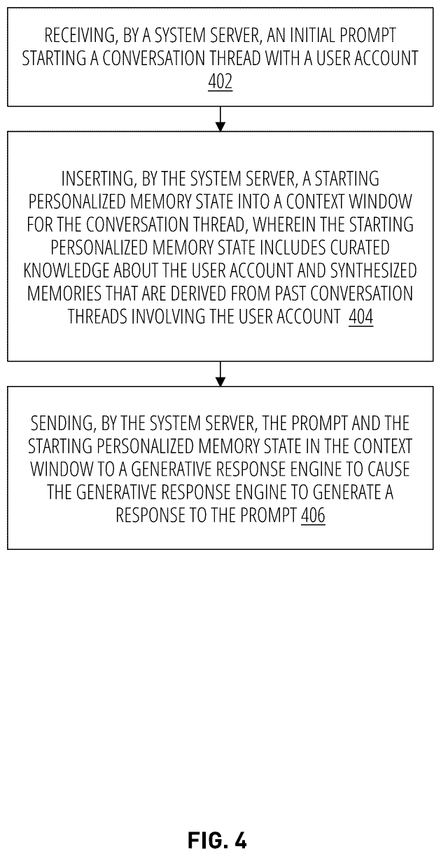

FIG. 4 illustrates an example method for context management for a generative response engine in accordance with some embodiments of the present technology. Although the example method depicts a particular sequence of operations, the sequence may be altered without departing from the scope of the present disclosure. For example, some of the operations depicted may be performed in parallel or in a different sequence that does not materially affect the function of the method. In other examples, different components of an example device or system that implements the method may perform functions at substantially the same time or in a specific sequence.

According to some examples, the method includes receiving, by a system server, an initial prompt 124 starting a conversation thread with a user account at block 402. For example, the context management service 120 in FIG. 1 may embody the system server and may receive the initial prompt 124. The initial prompt 124 may include a natural language prompt, such as a typed prompt or a verbal prompt, code snippets, mathematical/scientific notations, media-based prompts, such as images, audio, or videos, embodied cognition prompts, such as multimodal inputs from various sensors or wearable devices, graph-based prompts, or any other type of inputs that a generative response engine 110, such as a large language model, can receive. For non-text based prompts, the provided media or multi-modal input may be described in natural language.

According to some examples, the method includes inserting, by the system server, a personalized memory state 202 into a context window 210 for the conversation thread at block 404. For example, the context management service 120 in FIG. 1 may insert the personalized memory state 202 into the context window. The personalized memory state 202 may include curated knowledge 206 about the user account and synthesized memories 208 that are derived from past conversation threads involving the user account. The context window 210 may be a finite space within which the generative response engine generates responses based on the information provided in the prompt 124 and personalized memory state 202. The personalized memory state 202 enables the generative response engine to take into account preferences and past conversations of the user account, as well as other relevant context, when generating the response.

In some cases, the curated knowledge 206 is a collection of statements stored in a personalization notepad reflecting facts about a user of the user account and learned preferences of the user of the user account. The generative response engine 110 may determine that information within the prompt, or a user reaction to a response, should be written to the personalization notepad. The generative response engine 110 may then write the information into the personalization notepad, whereby the generative response engine has access to the curated knowledge 206 which includes the facts about the user of the user account and the learned preferences of the user of the user account. In some cases, the learned preferences may be data stored based on feedback from the user account, such as when the user account responds to a response by giving a thumbs up or a thumbs down. In some cases, the learned preferences may be pulled from the archive of past interactions, the synthesized memories 208, or a combination thereof.

In some cases, the personalized memory state 202 additionally includes short-term memory 204. The short-term memory 204 may include at least a portion of recent conversations threads. The short-term memory 204 may include a portion of recent but different conversations threads, which are typically limited by recency and the limited context window 210.

According to some examples, the method includes sending, by the system server, the prompt 124 and the personalized memory state 202 in the context window 210 to the generative response engine 110 at block 406. The generative response engine 110 may receive the prompt 124 and the personalized memory state 202 to generate a response to the prompt 124. For example, the context management service 120 in FIG. 1 may include the prompt 124 and the personalized memory state 202 in the context window 210 of the generative response engine 110. In some cases, the generative response engine 110 is trained to determine how or whether to utilize the personalized memory state 202 when generating the response to the prompt 124.

For example, the generative response engine 110 may have been trained to generate relevant responses to prompts based on the prompt and the personalized memory state. Some responses to prompts will not benefit from context in the personalized memory state, whereas some responses to prompts will benefit from content in the personalized memory state. Depending on the type of generative response engine, the determination of whether to incorporate context from the personalized memory state 202 into the response generation process can manifest itself through selection of tokens and scoring of possible response outputs, and/or the determination can be influenced by explicit reasoning generated by the generative response engine. As such, while the generative response engine 110 is trained to determine what parts of the personalized memory state 202 are most relevant or useful in generating a coherent and accurate response, the generative response engine 110 might make this determination implicitly through scoring of final response, explicitly through reasoning that part of the personalized memory state is relevant to the response generation, or a combination of these techniques.

In general, the generative response engine 110 may be implicitly or explicitly trained to balance the influence of the various features of the personalized memory state 202, such as the curated knowledge 206, the synthesized memories 208, and the short-term memories 204, when determining how much weight to assign to various features of each, by training the generative response engine to output relevant responses that are contextually relevant to prior interactions the user account has had with AI assistant service 100. As part of the training some cases, the generative response engine 110 may also be designed to override or modify suggestions from the personalized memory state 202 in favor of other competing factors, such as fact-based knowledge about real-world events.

This could involve incorporating external knowledge sources, using heuristics or rules-based systems, or employing additional machine learning techniques to improve the response.

In some cases, based on the prompt 124 and the personalized memory state 202, the generative response engine 110 may determine to search an archive of past interactions between the user account and the generative response engine service provider. The personalized memory state 202 may include summaries or lists of past conversation threads as part of the synthesized memories 208. The generative response engine 110 can be caused to determine that it should search the contents of past conversation threads, based in part on the summaries or lists of past conversation threads, or based on the prompt itself suggesting that a conversation thread that is relevant to the prompt might exist.

For example, a searchable index of the archive of past interactions may be created. The searchable index may be based on conversation threads between the user account and the generative response engine service provider. The creation of the searchable index may be achieved by first, creating searchable representations of at least portions of the conversation threads in the archive of past interactions. The searchable representations may be chunks of text, audio, or video from the conversation threads, that are stored in the searchable index. The chunks may be vectors and subsets of the conversation threads, while the searchable index may be a vector database. The text chunks may overlap with adjacent text chunks from the same conversation thread to improve the searchability of the searchable index.

In some cases, the searching may be performed using a file search tool that is designed to enable efficient search and retrieval operations. The file search tool may take in a collection of files and parse them into manageable chunks, embedding these chunks into a vector store. The vector store may provide precise search capabilities, making it easier to find specific information within the files. These parsed chunks may then indexed, facilitating the ability to provide contextually relevant responses. The generative response engine 110 may then access the index to generate answers that are pertinent to the user's query. The file search tool may play a crucial role in accessing the archive of past interactions, which can be thought of as long-term memory.

As addressed herein, the present technology also includes an analog to short-term memory. When a user engages with the AI assistant service 100, their conversation history is temporarily stored in short-term memory 204, allowing for seamless recall and response to subsequent queries. However, even after the conversation thread is no longer included in the short-term memory, the conversation thread is still accessible in long-term memory (archive of past interactions), where it becomes part of the virtual assistant's vast knowledge repository. The archive of past interactions or long-term memory is distinguishable from the curated knowledge 206 and the synthesized memories 208 in that the long-term memory is all of the past interactions that have been archived.

The file search tool may serve as a mechanism for retrieving the archive of past interactions. The file search tool essentially acts as a digital archive, enabling the AI assistant service 100 to draw upon its vast repository of past interactions to inform and improve future responses. In some cases, the file search tool can optimize parameters such as chunk size and overlap based on specific use cases. The file search tool may also generate the index with an index identifier, which enables easy identification by virtual assistants and convenient mapping of permission relationships between them and the indexes. This index may be a vector store, representing chunks of files or the entire file as vectors embedded with the meaning of these chunks. More information about how the file search tool may function is described in U.S. application Ser. No. 19/047,982, filed on Feb. 7, 2025, and titled “VIRTUAL ASSISTANTS API,” which is incorporated by reference herein.

In some cases, the generative response engine 110 may receive search results from the search of the archive of past interactions. The generative response engine 110 may generate the response to the prompt 124 from the context window 210 that includes at least the search results and the personalized memory state 202. The generative response engine 110 may be configured to determine whether the search results or contents of the personalized memory state 202 are relevant for generating the response to the prompt 124. By learning to distinguish between essential and extraneous data, the generative response engine 110 may produce high-quality answers even when faced with superfluous information. The training process may involve exposing the generative response engine 110 to a wide range of inputs, including those that contain redundant or irrelevant data, and challenging it to identify what is truly relevant for generating an effective response.

For instance, consider the scenario where the prompt 124 is “What are the health benefits of eating blueberries?” The search results from past interactions may include a list of potential health benefits, as well as some unrelated information about the nutritional content of other fruits. In this case, the generative response engine 110 would need to determine which pieces of information are relevant for answering the user's question. To achieve this, the generative response engine 110 may be trained on a dataset that includes examples like “The search results for ‘health benefits of blueberries’ include: high in antioxidants, may help lower blood pressure. However, we also found some unrelated information about strawberries being rich in vitamin C.” The model learns to recognize that only certain pieces of information are directly relevant to answering the user's question. The training process may involve a combination of supervised learning, where the generative response engine 110 is labeled with correct answers to specific questions, and unsupervised learning, where it learns patterns and relationships in large datasets.

In some cases, after receiving the initial prompt 124 and the personalized memory state 202, the generative response engine 110 may review contents of the context window 210 and determine to remove portions, such as irrelevant portions, of the personalized memory state 202 from the context window 210. In some cases, the generative response engine 110 may determine to summarize at least a portion of the personalized memory state 202 in the context window to yield at least a shortened portion of the personalized memory state 202. By summarizing, more room may be made available in the context window 210.

The generative response engine 110 may be trained to review the context window 210 to determine that portions of the synthesized memories 208 are not relevant to the thread and should be removed. In some cases, the reviewing may be limited to when the context window 210 is reaching capacity and there is a need to make room to add other relevant data, such as from searching the archive of past interactions or past conversations.

In some cases, the specialized instance 212 of the generative response engine 110 may revise, add, or remove parts of the synthesized memories 208 in a subsequent occurrence. In some cases, the subsequent occurrence is subsequent to the asynchronous evaluation of the past conversation thread. For example, if a user revisits an earlier conversation topic or introduces new information, the specialized instance 212 may update its existing synthesized memories 208 to reflect such changes. The revision process may also enable the specialized instance 212 to learn from user feedback and preferences, refining its generation of synthesized memories 208. In other cases, the specialized instance 212 may use the revised memories to inform subsequent interactions with the AI assistant service 100.

The revision process may be analogous to how brains process and retain memories: just as connections in the brain can be strengthened or weakened over time, the synthesized memories 208 can be updated, modified, or removed based on new information and user interactions. Similarly, the revised memories can serve as a kind of ‘mental anchor’ that helps the specialized instance 212 recall relevant information from past conversations. As such, the revision process is akin to how brains can be prompted to remember past thoughts or experiences through various means, such as recalling similar contexts or emotions. In some cases, as a results of the revision of the synthesized memories 208, a summary of the at least one topic that was previously part of the synthesized memories may be removed. As a result, the removed summary may be moved into an archive of past interactions for later search and retrieval.

In some cases, the specialized instance 212 of the generative response engine 110 may determine that the past conversation threads indicate at least two distinct usage profiles of the generative response engine 110 by the user account. As such, the creation of the synthesized memories 208 may include creating at least a first set of synthesized memories 208 and a second set of synthesized memories 208, where the first set of synthesized memories 208 correspond to a first distinct usage profile, and the second set of synthesized memories 208 that correspond to the second distinct usage profile. For example, the first distinct usage profile pertains to business conversation threads, whereas the second distinct usage profile pertains to personal conversation threads.

When there are different sets of synthesized memories 208 present, the personalized memory state 202 may include separate summaries for the different sets of synthesized memories 208. In some cases, based the prompt 124 and the summary of the first set of the synthesized memories 208 and the summary of the second set of the synthesized memories 208, the generative response engine 110 may determine that the first set of synthesized memories 208 is more related to the prompt 124. As such, the generative response engine 110 may retrieve the first set of synthesized memories 208 to be included in the context window 210 to be referenced while responding to the prompt 124.

In some cases, the generative response engine 110 may reason over the prompt 124 and the personalized memory state 202 about whether portions of the personalized memory state 202 are relevant to the prompt 124 and should be used in generating the response to the prompt. The reasoning may be performed by a reasoning model of the generative response engine. The reasoning model may output a chain of thought and use the chain of thought to guide an inference operation and creation of the final output.

The reasoning may involve evaluating the semantic similarity between the prompt and each portion of the personalized memory state, and selecting only those portions that are most relevant to the task at hand. This may involve using various inference rules or heuristics to guide the reasoning process, such as identifying keywords or entities mentioned in both the prompt and the personalized memory state. The reasoning model may output a chain of thought that represents the selected portion of the personalized memory state, which is then used to guide an inference operation to generate the final response. This final output may be a rewritten version of the original prompt, with additional information or context added based on the inferences made from the personalized memory state.

For example, if the prompt is “What's the latest news on [topic]?”, the generative response engine 110 might identify a relevant portion of the personalized memory state that mentions a similar topic, and use this to guide an inference operation to generate a response. More specifically, the personalized memory state might reflect the user account's most recent knowledge on a topic that will inform that the term “latest” might mean in the prompt (e.g., more recent than the user account's most recent knowledge). The reasoning model may output a chain of thought that represents the selected portion of the personalized memory state, which is then used to guide an inference operation to generate the final response. The final output may be a rewritten version of the original prompt, with additional information or context added based on the inferences made from the personalized memory state. This can include adding relevant details, examples, or analogies to help illustrate the response and make it more engaging for the user. In some cases, the generative response engine may also use the chain of thought output by the reasoning model to generate a summary or overview of the relevant information in the personalized memory state. This can be particularly useful when generating responses that require summarizing large amounts of data or extracting key insights from a complex conversation history.

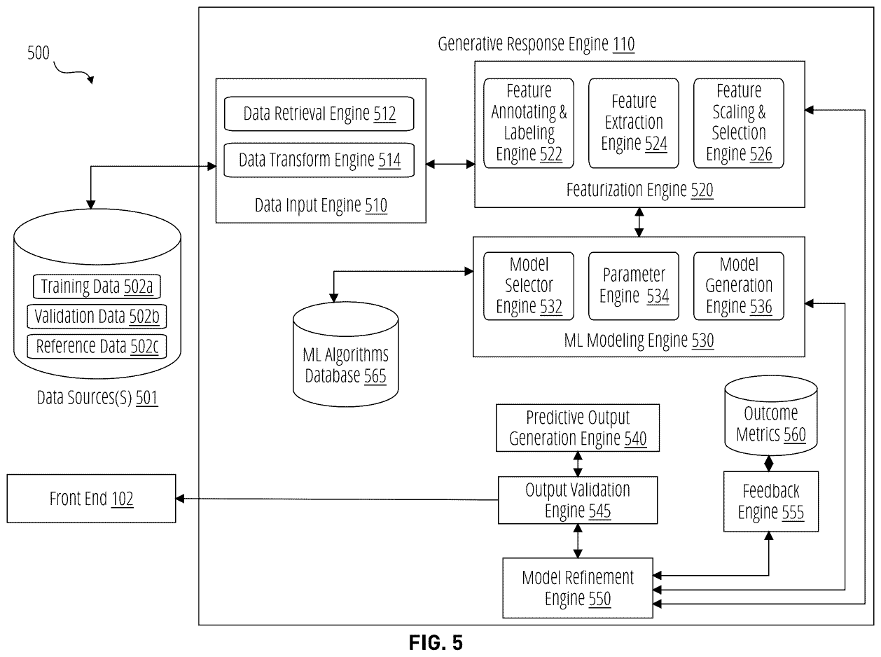

FIG. 5 is a block diagram illustrating an example machine learning platform for implementing various aspects of this disclosure in accordance with some aspects of the present technology. Although the example system depicts particular system components and an arrangement of such components, this depiction is to facilitate a discussion of the present technology and should not be considered limiting unless specified in the appended claims. For example, some components that are illustrated as separate can be combined with other components, and some components can be divided into separate components.

System 500 may include data input engine 510 that can further include data retrieval engine 512 and data transform engine 514. Data retrieval engine 512 may be configured to access, interpret, request, or receive data, which may be adjusted, reformatted, or changed (e.g., to be interpretable by another engine, such as data input engine 510). For example, data retrieval engine 512 may request data from a remote source using an API. Data input engine 510 may be configured to access, interpret, request, format, re-format, or receive input data from data sources(s) 501. For example, data input engine 510 may be configured to use data transform engine 514 to execute a re-configuration or other change to data, such as a data dimension reduction. In some aspects, data sources(s) 501 may be associated with a single entity (e.g., organization) or with multiple entities. Data sources(s) 501 may include one or more of training data 502a (e.g., input data to feed a machine learning model as part of one or more training processes), validation data 502b (e.g., data against which at least one processor may compare model output with, such as to determine model output quality), and/or reference data 502c. In some aspects, data input engine 510 can be implemented using at least one computing device. For example, data from data sources(s) 501 can be obtained through one or more I/O devices and/or network interfaces. Further, the data may be stored (e.g., during execution of one or more operations) in a suitable storage or system memory. Data input engine 510 may also be configured to interact with a data storage, which may be implemented on a computing device that stores data in storage or system memory.

System 500 may include featurization engine 520. Featurization engine 520 may include feature annotating & labeling engine 522 (e.g., configured to annotate or label features from a model or data, which may be extracted by feature extraction engine 524), feature extraction engine 524 (e.g., configured to extract one or more features from a model or data), and/or feature scaling & selection engine 526 Feature scaling & selection engine 526 may be configured to determine, select, limit, constrain, concatenate, or define features (e.g., AI features) for use with AI models.

System 500 may also include machine learning (ML) ML modeling engine 530, which may be configured to execute one or more operations on a machine learning model (e.g., model training, model re-configuration, model validation, model testing), such as those described in the processes described herein. For example, ML modeling engine 530 may execute an operation to train a machine learning model, such as adding, removing, or modifying a model parameter. Training of a machine learning model may be supervised, semi-supervised, or unsupervised. In some aspects, training of a machine learning model may include multiple epochs, or passes of data (e.g., training data 502a) through a machine learning model process (e.g., a training process). In some aspects, different epochs may have different degrees of supervision (e.g., supervised, semi-supervised, or unsupervised). Data into a model to train the model may include input data (e.g., as described above) and/or data previously output from a model (e.g., forming a recursive learning feedback). A model parameter may include one or more of a seed value, a model node, a model layer, an algorithm, a function, a model connection (e.g., between other model parameters or between models), a model constraint, or any other digital component influencing the output of a model. A model connection may include or represent a relationship between model parameters and/or models, which may be dependent or interdependent, hierarchical, and/or static or dynamic. The combination and configuration of the model parameters and relationships between model parameters discussed herein are cognitively infeasible for the human mind to maintain or use. Without limiting the disclosed aspects in any way, a machine learning model may include millions, billions, or even trillions of model parameters. ML modeling engine 530 may include model selector engine 532 (e.g., configured to select a model from among a plurality of models, such as based on input data), parameter engine 534 (e.g., configured to add, remove, and/or change one or more parameters of a model), and/or model generation engine 536 (e.g., configured to generate one or more machine learning models, such as according to model input data, model output data, comparison data, and/or validation data).

In some embodiments, model selector engine 532 may be configured to receive input and/or transmit output to ML algorithms database 565. Similarly, featurization engine 520 can utilize storage or system memory for storing data and can utilize one or more I/O devices or network interfaces for transmitting or receiving data. ML algorithms database 565 may store one or more machine learning models, any of which may be fully trained, partially trained, or untrained. A machine learning model may be or include, without limitation, one or more of (e.g., such as in the case of a metamodel) a statistical model, an algorithm, a neural network (NN), a convolutional neural network (CNN), a generative neural network (GNN), a Word2Vec model, a bag of words model, a term frequency-inverse document frequency (tf-idf) model, a GPT (Generative Pre-trained Transformer) model (or other autoregressive model), a diffusion model, a diffusion-transformer model, an encoder such as BERT (Bidirectional Encoder Representations from Transformers) or LXMERT (Learning Cross-Modality Encoder Representations from Transformers), a Proximal Policy Optimization (PPO) model, a nearest neighbor model (e.g., k nearest neighbor model), a linear regression model, a k-means clustering model, a Q-Learning model, a Temporal Difference (TD) model, a Deep Adversarial Network model, or any other type of model described further herein. Some of the ML algorithms in ML algorithms database 565 can be considered generative response engines. Generative response engines are those models are commonly referred to as Generative AI, and that can receive an input prompt and generate additional content based on the prompt. GPTs, diffusion models, and diffusion-transformer models are some non-limiting examples of generative response engines. Some specific examples of generative response engines that can be stored in the ML algorithms database 565 include versions DALL.E, CHAT GPT, and SORA, all provided by OPEN AI.

System 500 can further include predictive output generation engine 540 and output validation engine 545 (e.g., configured to apply validation data to machine learning model output). Predictive output generation engine 540 can analyze the input and identify relevant patterns and associations in the data it has learned to generate a sequence of words that predictive output generation engine 540 predicts is the most likely continuation of the input using one or more models from the ML algorithms database 565, aiming to provide a coherent and contextually relevant answer. Predictive output generation engine 540 generates responses by sampling from the probability distribution of possible words and sequences, guided by the patterns observed during its training. In some embodiments, predictive output generation engine 540 can generate multiple possible responses before presenting the final one. Predictive output generation engine 540 can generate multiple responses based on the input, and these responses are variations that predictive output generation engine 540 considers potentially relevant and coherent. Output validation engine 545 can evaluate these generated responses based on certain criteria. These criteria can include relevance to the prompt, coherence, fluency, and sometimes adherence to specific guidelines or rules, depending on the application. Based on this evaluation, output validation engine 545 selects the most appropriate response. This selection is typically the one that scores highest on the set criteria, balancing factors like relevance, informativeness, and coherence. The most appropriate response may be sent to the front end 102 (e.g., front end 102). In some cases the generative response engine 110 includes the predictive output generation engine 540 and the output validation engine 545.

System 500 can further include feedback engine 555 (e.g., configured to apply feedback from a user and/or machine to a model) and model refinement engine 550 (e.g., configured to update or re-configure a model). In some aspects, feedback engine 555 may receive input and/or transmit output (e.g., output from a trained, partially trained, or untrained model) to outcome metrics database 560. Outcome metrics database 560 may be configured to store output from one or more models and may also be configured to associate output with one or more models. In some aspects, outcome metrics database 560, or other device (e.g., model refinement engine 550 or feedback engine 555), may be configured to correlate output, detect trends in output data, and/or infer a change to input or model parameters to cause a particular model output or type of model output. In some aspects, model refinement engine 550 may receive output from predictive output generation engine 540 or output validation engine 545. In some aspects, model refinement engine 550 may transmit the received output to featurization engine 520 or ML modeling engine 530 in one or more iterative cycles.

In some cases, data input engine 510, featurization engine 520, ML modeling engine 530, predictive output generation engine 540, output validation engine 545, model refinement engine 550, feedback engine 555, outcome metrics database 560 are a part of generative response engine 110. It is to be understood that the generative response engine 110 may include some or all of these components, and/or additional components not listed here. Furthermore, certain components may be located in other modules or systems within the overall system architecture. The generative response engine 110 may also include additional functionality not described herein, and certain components may be integrated into other modules or systems within the overall AI assistant service 100. In addition, it is to be understood that the generative response engine 110 can be modified, replaced, or augmented with additional components or functionality as needed to achieve specific performance or functional requirements.

The engines of system 500 may be packaged functional hardware units designed for use with other components or a part of a program that performs a particular function (e.g., of related functions). Any or each of these modules may be implemented using a computing device. In some aspects, the functionality of system 500 may be split across multiple computing devices to allow for distributed processing of the data, which may improve output speed and reduce computational load on individual devices. In some aspects, system 500 may use load-balancing to maintain stable resource load (e.g., processing load, memory load, or bandwidth load) across multiple computing devices and to reduce the risk of a computing device or connection becoming overloaded. In these or other aspects, the different components may communicate over one or more I/O devices and/or network interfaces.

System 500 can be related to different domains or fields of use. Descriptions of aspects related to specific domains, such as natural language processing or language modeling, is not intended to limit the disclosed aspects to those specific domains, and aspects consistent with the present disclosure can apply to any domain that utilizes predictive modeling based on available data.

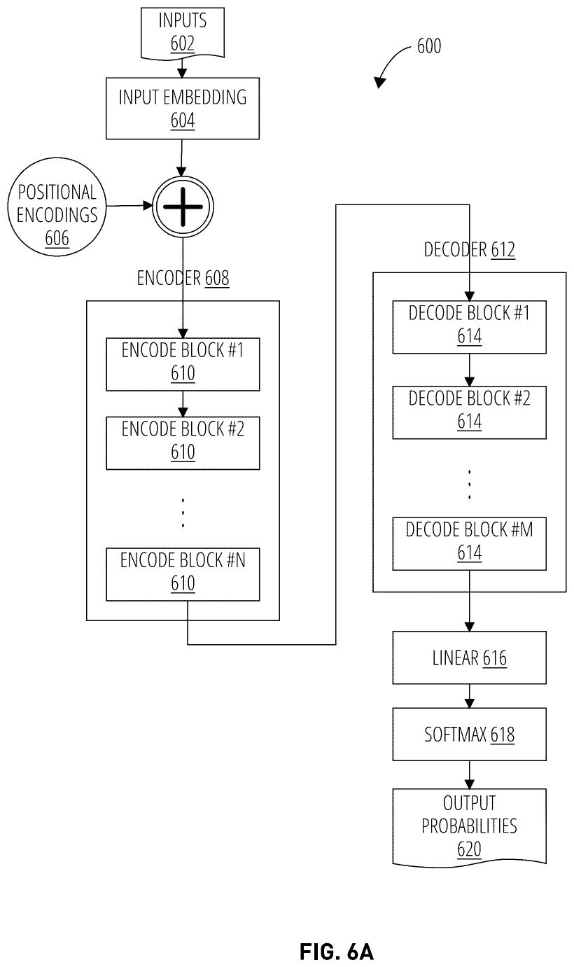

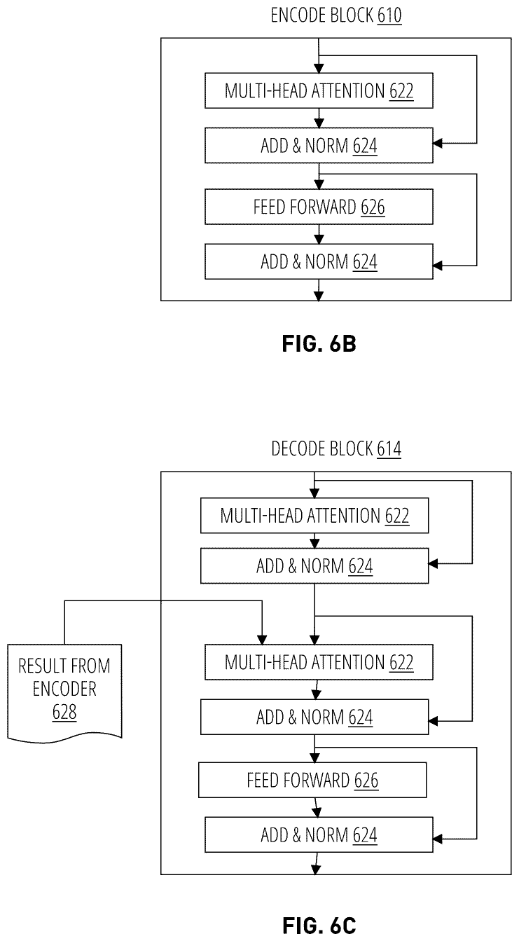

FIG. 6A, FIG. 6B, and FIG. 6C illustrates an example transformer architecture in accordance with some embodiments of the present technology.

Examples of ML models that use a transformer neural network (e.g., transformer architecture 600) can include, e.g., generative pretrained transformer (GPT) models and Bidirectional Encoder Representations from Transformer (BERT) models. The transformer architecture 600, which is illustrated in FIG. 6A, FIG. 6B, and FIG. 6C, includes inputs 602, input embedding block 604, positional encodings 606, encoder 608 including encode blocks 610, decoder 612 including decode blocks 614, linear block 616, softmax block 618, and output probabilities 620.

Input embedding block 604 is used to provide representations for words. For example, embedding can be used in text analysis. According to certain non-limiting examples, the representation is a real-valued vector that encodes the meaning of the word in such a way that words that are closer in the vector space are expected to be similar in meaning. Word embeddings can be obtained using language modeling and feature learning techniques, where words or phrases from the vocabulary are mapped to vectors of real numbers. According to certain non-limiting examples, the input embedding block 604 can be learned embeddings to convert the input tokens and output tokens to vectors of dimension that have the same dimension as the positional encodings, for example.

Positional encodings 606 provide information about the relative or absolute position of the tokens in the sequence. According to certain non-limiting examples, positional encodings 606 can be provided by adding positional encodings to the input embeddings at the inputs to the encoder 608 and decoder 612. The positional encodings have the same dimension as the embeddings, thereby enabling a summing of the embeddings with the positional encodings.

There are several ways to realize the positional encodings, including learned and fixed. For example, sine and cosine functions having different frequencies can be used. That is, each dimension of the positional encoding corresponds to a sinusoid. Other techniques of conveying positional information can also be used, as would be understood by a person of ordinary skill in the art. For example, learned positional embeddings can instead be used to obtain similar results. An advantage of using sinusoidal positional encodings rather than learned positional encodings is that doing so allows the model to extrapolate to sequence lengths longer than the ones encountered during training.

Encoder 608 can use stacked self-attention and point-wise, fully connected layers. Encoder 608 can be a stack of N identical layers (e.g., N=6), and each layer can be an encode block, as illustrated by encode block 610 shown in FIG. 6B. Each encode block 610 has two sub-layers: (i) a first sub-layer has a multi-head attention block 622 and (ii) a second sub-layer has a feed forward block 626, which can be a position-wise fully connected feed-forward network. The feed forward block 626 can use a rectified linear unit (ReLU).

Encoder 608 uses a residual connection around each of the two sub-layers, followed by an add & norm block 624, which performs normalization. For example, the output of each sub-layer can be LayerNorm(x+Sublayer(x)). To facilitate these residual connections, all sub-layers in the model, as well as the embedding layers, produce output data having a same dimension.

Similar to encoder 608, decoder 612 uses stacked self-attention and point-wise, fully connected layers. Decoder 612 can also be a stack of M identical layers (e.g., M=6), and each layer can be a decode block, as illustrated by decoder 612 shown in FIG. 6B. In addition to the two sub-layers (i.e., the sublayer with multi-head attention block 622 and the sub-layer with feed forward block 626) found in encode block 610, decode block 614 can include a third sub-layer, which performs multi-head attention over the output of the encoder stack. Similar to encoder 608, decoder 612 uses residual connections around each of the sub-layers, followed by layer normalization. Additionally, the sub-layer with multi-head attention block 622 can be modified in the decoder stack to prevent positions from attending to subsequent positions. This masking, combined with the fact that the output embeddings are offset by one position, can ensure that the predictions for position i can depend only on the known output data at positions less than i.

Linear block 616 can be a learned linear transformation. For example, when transformer architecture 600 is being used to translate from a first language into a second language, linear block 616 can project the output from the last decode softmax block 618 into word scores for the second language (e.g., a score value for each unique word in the target vocabulary) at each position in the sentence. For instance, if the output sentence has seven words and the provided vocabulary for the second language has 10,000 unique words, then 10,000 score values are generated for each of those seven words. The score values indicate the likelihood of occurrence for each word in the vocabulary in that position of the sentence.

Softmax block 618 then turns the scores from linear block 616 into output probabilities 620 (which add up to 1.0). In each position, the index provides for the word with the highest probability, and then maps that index to the corresponding word in the vocabulary. Those words then form the output sequence of transformer architecture 600. The softmax operation is applied to the output from linear block 616 to convert the raw numbers into output probabilities 620 (e.g., token probabilities).

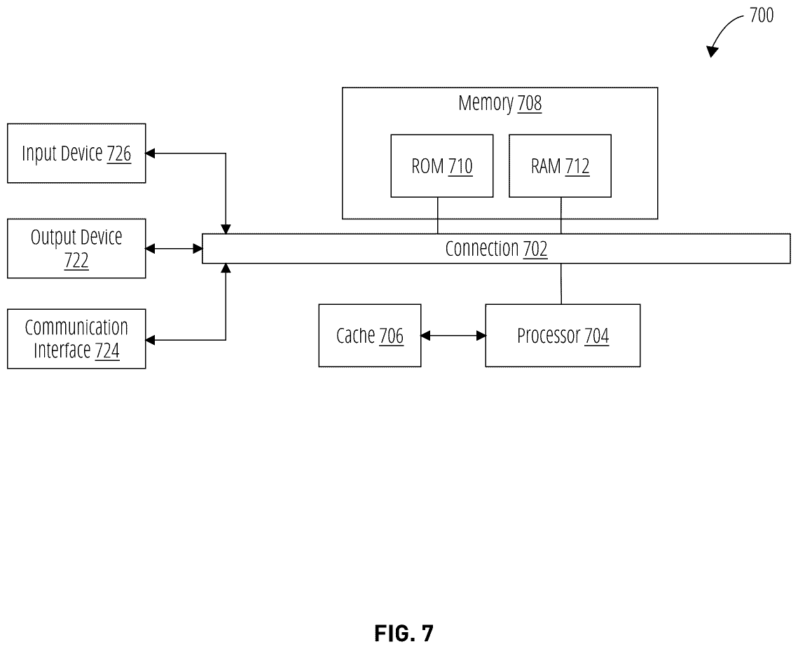

FIG. 7 shows an example of computing system 700, which can be, For example, any computing device making up any engine illustrated in FIG. 1 and FIG. 2 or any component thereof.

In some embodiments, computing system 700 is a single device, or a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

In some embodiments, computing system 700 may comprise one or more computing resources provisioned from a “cloud computing” provider, For example, AMAZON ELASTIC COMPUTE CLOUD (“AMAZON EC2”), provided by AMAZON, INC. of Seattle, Washington; SUN CLOUD COMPUTER UTILITY, provided by SUN MICROSYSTEMS, INC. of Santa Clara, California; AZURE, provided by MICROSOFT CORPORATION of Redmond, Washington, GOOGLE CLOUD PLATFORM, provided by ALPHABET, INC. of Mountain View, California, and the like.

Example computing system 700 includes at least one processing unit (CPU or processor) 704 and connection 702 that couples various system components including system memory 708, such as read-only memory (ROM) 710 and random access memory (RAM) 712 to processor 704. Memory 708 can be a volatile or non-volatile memory device, and can be a hard disk or other types of non-transitory computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

Memory 708 can include software services, servers, logic, etc., that when the code that defines such software is executed by the processor 704, it causes the system to perform a function. In some aspects, a hardware service that performs a particular function can include the software component stored in a computer-readable medium in connection with the necessary hardware components, such as processor 704, connection 702, output device 722, etc., to carry out the function.

Computing system 700 can include a cache of high-speed memory 706 connected directly with, in close proximity to, or integrated as part of processor 704.

Connection 702 can be a physical connection via a bus, or a direct connection into processor 704, such as in a chipset architecture. Connection 702 can also be a virtual connection, networked connection, or logical connection.

Processor 704 can include any general purpose processor and a hardware service or software service stored in memory 708, configured to control processor 704 as well as a special-purpose processor where software instructions are incorporated into the actual processor design. Processor 704 may essentially be a completely self-contained computing system, containing multiple cores or processors, a bus, memory controller, cache, etc. A multi-core processor may be symmetric or asymmetric. Processor 704 can be physical or virtual.

To enable user interaction, computing system 700 includes an input device 726, which can represent any number of input mechanisms, such as a microphone for speech, a touch-sensitive screen for gesture or graphical input, keyboard, mouse, motion input, speech, etc. Computing system 700 can also include output device 722, which can be one or more of a number of output mechanisms known to those of skill in the art. In some instances, multimodal systems can enable a user to provide multiple types of input/output to communicate with computing system 700. Computing system 700 can include communication interface 724, which can generally govern and manage the user input and system output. There is no restriction on operating on any particular hardware arrangement, and therefore the basic features here may easily be substituted for improved hardware or firmware arrangements as they are developed.

In some embodiments, computing system 700 can refer to a combination of a personal computing device interacting with components hosted in a data center, where both the computing device and the components in the data center. In such examples, both the personal computing device and the components in the datacenter might have a processor, cache, memory, storage, etc.

For clarity of explanation, in some instances, the present technology may be presented as including individual functional blocks including functional blocks comprising devices, device components, steps or methods in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some aspects, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, For example, instructions and data which cause or otherwise configure a general purpose computer, special purpose computer, or special purpose processing device to perform a certain function or group of functions. Portions of computer resources used can be accessible over a network. The executable computer instructions may be, For example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

### Aspects

The present technology includes computer-readable storage mediums for storing instructions, and systems for executing any one of the methods embodied in the instructions addressed in the aspects of the present technology presented below:

Aspect 1. A method comprising: receiving, by a system server, a prompt starting a conversation thread with a user account; inserting, by the system server, a personalized memory state into a context window for the conversation thread, wherein the personalized memory state includes curated knowledge about the user account and synthesized memories that are derived from past conversation threads involving the user account; and sending, by the system server, the prompt and the personalized memory state in the context window to a generative response engine to cause the generative response engine to generate a response to the prompt based on the prompt and the personalized memory state.

Aspect 2. The method of aspect 1, further comprising: reasoning, by the generative response engine, over the prompt and the personalized memory state about whether portions of the personalized memory state are relevant to the prompt and should be used in generating the response to the prompt.

Aspect 3. The method of any one of aspects 1-2, further comprising: based on the prompt and the personalized memory state, determining, by the generative response engine, to search an archive of past interactions between the user account and a generative response engine service provider; receiving, by the generative response engine, search results from the search of the archive of past interactions; and generating, by the generative response engine, the response to the prompt from the context window that includes at least the search results and the personalized memory state.

Aspect 4. The method of any one of aspects 1-3, wherein the personalized memory state includes short-term memory, wherein the short-term memory includes at least a portion of recent conversations threads, and wherein the response is generated based on the short-term memory.

Aspect 5. The method of any one of aspects 1-4, wherein the synthesized memories include a listing of topics derived from at least one of the past conversation threads or a summary of at least one topic that has occurred in the past conversation threads, further comprising: based on information in the synthesized memories, determining, by the generative response engine, to search an archive of past interactions to learn more about at least one topic in the listing of topics that is part of the synthesized memories.

Aspect 6. The method of any one of aspects 1-5, further comprising: evaluating the past conversation threads by a specialized instance of the generative response engine, wherein the specialized instance of the generative response engine is trained to determine what information should be synthesized into the synthesized memories; and creating the synthesized memories.

Aspect 7. The method of any one of aspects 1-6, further comprising: revising, by the specialized instance of the generative response engine, the synthesized memories in a subsequent occurrence by evaluating the past conversation threads; determining to remove the summary of the at least one topic that was previously part of the synthesized memories as a result of the revising of the synthesized memories; and storing the summary of the at least one topic to be removed from the synthesized memories into the archive of past interactions for later search and retrieval.

Aspect 8. The method of any one of aspects 1-7, further comprising: determining, by the specialized instance of the generative response engine, that the past conversation threads indicate at least two distinct usage profiles of the generative response engine by the user account, wherein the creating the synthesized memories includes creating at least a first set of synthesized memories and a second set of synthesized memories, the first set of synthesized memories correspond to a first distinct usage profile, and the second set of synthesized memories that correspond to a second distinct usage profile.

Aspect 9. The method of any one of aspects 1-8, when the first set of synthesized memories and the second set of synthesized memories are present, the personalized memory state includes a summary of the first set of the synthesized memories and the summary of the second set of the synthesized memories, the method comprising: based the prompt and the summary of the first set of the synthesized memories and the summary of the second set of the synthesized memories, determining, by the generative response engine, that the first set of synthesized memories is more related to the prompt; and retrieving, by the generative response engine, the first set of synthesized memories to be included in the context window to be referenced while responding to the prompt.

Aspect 10. The method of any one of aspects 1-9, further comprising: after receiving the prompt and the personalized memory state, reviewing contents of the context window; and determining to remove portions of the personalized memory state from the context window or to summarize at least a portion of the personalized memory state in the context window to yield at least a shortened portion of the personalized memory state, whereby more room is made available in the context window.

Aspect 11. The method of any one of aspects 1-10, wherein the curated knowledge is a collection of statements stored in a personalization notepad reflecting facts about a user of the user account and learned preferences of the user of the user account, further comprising: determining, by the generative response engine, that information within the prompt, or a user reaction to a response should be written to the personalization notepad; and writing, by the generative response engine, the information into the personalization notepad, whereby the generative response engine has access to the curated knowledge which includes the facts about the user of the user account and the learned preferences of the user of the user account.

Aspect 12. A computing system comprising: one or more processors; and one or more memory storing instructions that, when executed by the one or more processors, configure the apparatus to: receive, by a system server, a prompt starting a conversation thread with a user account; insert, by the system server, a personalized memory state into a context window for the conversation thread, wherein the personalized memory state includes curated knowledge about the user account and synthesized memories that are derived from past conversation threads involving the user account; and send, by the system server, the prompt and the personalized memory state in the context window to a generative response engine to cause the generative response engine to generate a response to the prompt based on the prompt and the personalized memory state.

Aspect 13. The computing system of aspect 12, wherein the instructions further configure the apparatus to: reason, by the generative response engine, over the prompt and the personalized memory state about whether portions of the personalized memory state are relevant to the prompt and should be used in generating the response to the prompt.

Aspect 14. The computing system of any one of aspects 12-13, wherein the instructions further configure the apparatus to: based on the prompt and the personalized memory state, determine, by the generative response engine, to search an archive of past interactions between the user account and a generative response engine service provider; receive, by the generative response engine, search results from the search of the archive of past interactions; and generate, by the generative response engine, the response to the prompt from the context window that includes at least the search results and the personalized memory state.

Aspect 15. The computing system of any one of aspects 12-14, wherein the personalized memory state includes short-term memory, wherein the short-term memory includes at least a portion of recent conversations threads, and wherein the response is generated based on the short-term memory.

Aspect 16. The computing system of any one of aspects 12-15, wherein the synthesized memories include a listing of topics derived from at least one of the past conversation threads or a summary of at least one topic that has occurred in the past conversation threads, wherein the instructions further configure the apparatus to: based on information in the synthesized memories, determine, by the generative response engine, to search an archive of past interactions to learn more about at least one topic in the listing of topics that is part of the synthesized memories.

Aspect 17. The computing system of any one of aspects 12-16, wherein the instructions further configure the apparatus to: evaluate the past conversation threads by a specialized instance of the generative response engine, wherein the specialized instance of the generative response engine is trained to determine what information should be synthesized into the synthesized memories; and create the synthesized memories.

Aspect 18. The computing system of any one of aspects 12-17, wherein the instructions further configure the apparatus to: revise, by the specialized instance of the generative response engine, the synthesized memories in a subsequent occurrence by evaluating the past conversation threads; determine to remove the summary of the at least one topic that was previously part of the synthesized memories as a result of the revising of the synthesized memories; and store the summary of the at least one topic to be removed from the synthesized memories into the archive of past interactions for later search and retrieval.

Aspect 19. The computing system of any one of aspects 12-18, wherein the instructions further configure the apparatus to: determine, by the specialized instance of the generative response engine, that the past conversation threads indicate at least two distinct usage profiles of the generative response engine by the user account, wherein the create the synthesized memories includes creating at least a first set of synthesized memories and a second set of synthesized memories, the first set of synthesized memories correspond to a first distinct usage profile, and the second set of synthesized memories that correspond to a second distinct usage profile.

Aspect 20. A non-transitory computer-readable storage medium, the computer-readable storage medium including instructions that when executed by a computer, cause the computer to: receive a prompt starting a conversation thread with a user account; insert a personalized memory state into a context window for the conversation thread, wherein the personalized memory state includes curated knowledge about the user account and synthesized memories that are derived from past conversation threads involving the user account; and send the prompt and the personalized memory state in the context window to a generative response engine to cause the generative response engine to generate a response to the prompt based on the prompt and the personalized memory state.

The present technology includes computer-readable storage mediums for storing instructions, and systems for executing any one of the methods embodied in the instructions addressed in the aspects of the present technology presented below:

1. A method comprising:
receiving, by a system server, a prompt starting a conversation thread with a user account;
inserting, by the system server, a personalized memory state into a context window for the conversation thread prior to starting an interference operation based on the prompt, wherein the personalized memory state includes curated facts in natural language about the user account and synthesized memories, the synthesized memories are natural-language narrative descriptions of the user account that were generated by a language model that periodically analyzes past conversation threads involving the user account in an asynchronous offline process prior to receipt of the prompt, a respective synthesized memory summarizing conceptual connections across multiple conversation threads and being stored as part of the personalized memory state in a persistent user profile to produce the natural-language narrative descriptions of the user account; and
sending, by the system server, the prompt and the personalized memory state in the context window to a language model generative response engine to cause the generative response engine to generate a response to the prompt based on the prompt and the personalized memory state.

2. The method of claim 1, further comprising:
reasoning, by the generative response engine, over the prompt and the personalized memory state about whether portions of the personalized memory state are relevant to the prompt and should be used in generating the response to the prompt.

3. The method of claim 1, further comprising:
based on the prompt and the personalized memory state, determining, by the generative response engine, to search an archive of past interactions between the user account and a generative response engine service provider;
receiving, by the generative response engine, search results from the search of the archive of past interactions; and
generating, by the generative response engine, the response to the prompt from the context window that includes at least the search results and the personalized memory state.

4. The method of claim 1, wherein the synthesized memories includes short-term memory, wherein the short-term memory includes at least a portion of recent conversations threads, and wherein the response is generated based on the short-term memory.

5. The method of claim 1, wherein the synthesized memories include a listing of topics derived from at least one of the past conversation threads or a summary of at least one topic that has occurred in the past conversation threads, further comprising:
based on information in the synthesized memories, determining, by the generative response engine, to search an archive of past interactions to learn more about at least one topic in the listing of topics that is part of the synthesized memories.

6. The method of claim 5, further comprising:
evaluating the past conversation threads by a specialized instance of the generative response engine, wherein the specialized instance of the generative response engine is trained to determine what information should be synthesized into the synthesized memories; and
creating the synthesized memories.

7. The method of claim 6, further comprising:
revising, by the specialized instance of the generative response engine, the synthesized memories in a subsequent occurrence by evaluating the past conversation threads;
determining to remove the summary of the at least one topic that was previously part of the synthesized memories as a result of the revising of the synthesized memories; and
storing the summary of the at least one topic to be removed from the synthesized memories into the archive of past interactions for later search and retrieval.

8. The method of claim 6, further comprising:
determining, by the specialized instance of the generative response engine, that the past conversation threads indicate at least two distinct usage profiles of the generative response engine by the user account,
wherein the creating the synthesized memories includes creating at least a first set of synthesized memories and a second set of synthesized memories, the first set of synthesized memories correspond to a first distinct usage profile, and the second set of synthesized memories that correspond to a second distinct usage profile.

9. The method of claim 8, when the first set of synthesized memories and the second set of synthesized memories are present, the personalized memory state includes a summary of the first set of the synthesized memories and the summary of the second set of the synthesized memories, the method comprising:
based the prompt and the summary of the first set of the synthesized memories and the summary of the second set of the synthesized memories, determining, by the generative response engine, that the first set of synthesized memories is more related to the prompt; and
retrieving, by the generative response engine, the first set of synthesized memories to be included in the context window to be referenced while responding to the prompt.

10. The method of claim 1, further comprising:
after receiving the prompt and the personalized memory state, reviewing contents of the context window; and
determining to remove portions of the personalized memory state from the context window or to summarize at least a portion of the personalized memory state in the context window to yield at least a shortened portion of the personalized memory state, whereby more room is made available in the context window.

11. The method of claim 1, wherein the curated facts are a collection of statements stored in a personalization notepad reflecting facts about a user of the user account and learned preferences of the user of the user account, further comprising:
determining, by the generative response engine, that information within the prompt, or a user reaction to a response should be written to the personalization notepad; and
writing, by the generative response engine, the information into the personalization notepad, whereby the generative response engine has access to the curated knowledge which includes the facts about the user of the user account and the learned preferences of the user of the user account.

12. A computing system comprising:
one or more processors; and
one or more memory storing instructions that, when executed by the one or more processors, configure the computing system to:
receive, by a system server, a prompt starting a conversation thread with a user account;
insert, by the system server, a personalized memory state into a context window for the conversation thread prior to starting an interference operation based on the prompt, wherein the personalized memory state includes curated knowledge about the user account and synthesized memories, the synthesized memories are narrative natural-language descriptions of the user account that were generated by a language model that periodically analyzes past conversation threads involving the user account in an asynchronous offline process prior to receipt of the prompt, a respective synthesized memory summarizing conceptual connections across multiple conversation threads and being stored as part of the personalized memory state in a persistent user profile to produce the natural-language descriptions of the user account; and
send, by the system server, the prompt and the personalized memory state in the context window to a generative response engine to cause the generative response engine to generate a response to the prompt based on the prompt and the personalized memory state.

13. The computing system of claim 12, wherein the instructions further configure the computing system to:
reason, by the generative response engine, over the prompt and the personalized memory state about whether portions of the personalized memory state are relevant to the prompt and should be used in generating the response to the prompt.

14. The computing system of claim 12, wherein the instructions further configure the computing system to:
based on the prompt and the personalized memory state, determine, by the generative response engine, to search an archive of past interactions between the user account and a generative response engine service provider;
receive, by the generative response engine, search results from the search of the archive of past interactions; and
generate, by the generative response engine, the response to the prompt from the context window that includes at least the search results and the personalized memory state.

15. The computing system of claim 12, wherein the synthesized memories includes short-term memory, wherein the short-term memory includes at least a portion of recent conversations threads, and wherein the response is generated based on the short-term memory.

16. The computing system of claim 12, wherein the synthesized memories include a listing of topics derived from at least one of the past conversation threads or a summary of at least one topic that has occurred in the past conversation threads, wherein the instructions further configure the computing system to:
based on information in the synthesized memories, determine, by the generative response engine, to search an archive of past interactions to learn more about at least one topic in the listing of topics that is part of the synthesized memories.

17. The computing system of claim 16, wherein the instructions further configure the computing system to:
evaluate the past conversation threads by a specialized instance of the generative response engine, wherein the specialized instance of the generative response engine is trained to determine what information should be synthesized into the synthesized memories; and
create the synthesized memories.

18. The computing system of claim 17, wherein the instructions further configure the computing system to:
revise, by the specialized instance of the generative response engine, the synthesized memories in a subsequent occurrence by evaluating the past conversation threads;
determine to remove the summary of the at least one topic that was previously part of the synthesized memories as a result of the revising of the synthesized memories; and
store the summary of the at least one topic to be removed from the synthesized memories into the archive of past interactions for later search and retrieval.

19. The computing system of claim 17, wherein the instructions further configure the computing system to:
determine, by the specialized instance of the generative response engine, that the past conversation threads indicate at least two distinct usage profiles of the generative response engine by the user account,
wherein the create the synthesized memories includes creating at least a first set of synthesized memories and a second set of synthesized memories, the first set of synthesized memories correspond to a first distinct usage profile, and the second set of synthesized memories that correspond to a second distinct usage profile.

20. A non-transitory computer-readable storage medium, the computer-readable storage medium including instructions that when executed by a computer, cause the computer to:
receive a prompt starting a conversation thread with a user account;
insert a personalized memory state into a context window for the conversation thread prior to starting an interference operation based on the prompt, wherein the personalized memory state includes curated knowledge about the user account and synthesized memories, the synthesized memories are natural-language descriptions of the user account that were generated by a language model that periodically analyzes past conversation threads involving the user account in an asynchronous offline process prior to receipt of the prompt, a respective synthesized memory summarizing conceptual connections across multiple conversation threads and being stored as part of the personalized memory state in a persistent user profile to produce the natural-language descriptions of the user account; and
send the prompt and the personalized memory state in the context window to a generative response engine to cause the generative response engine to generate a response to the prompt based on the prompt and the personalized memory state.

21. (canceled)

22. The method of claim 1, wherein the synthesized memories were generated prior to receipt of the prompt and are stored as a persistent user profile accessible across multiple conversation sessions.

23. The method of claim 1, wherein the curated facts include facts and preferences associated with the user account that are generated by a language model generative response engine during interactions between the user account and the language model generative response engine.
